(19) United States
(12) Patent Application Publication
(10) Pub. No.: US 2013/0207905 A1
(43) Pub. Date: Aug. 15, 2013

(54) Input Lock For Touch-Screen Device

(71) Applicants: Linh Hankins, Milpitas, CA (US); Matthew DePetro, Sunnyvale, CA (US); Hideaki Tanioka, San Jose, CA (US)

(72) Inventors: Linh Hankins, Milpitas, CA (US); Matthew DePetro, Sunnyvale, CA (US); Hideaki Tanioka, San Jose, CA (US)

(73) Assignee: FUJITSU LIMITED, Kanagawa (JP)

(21) Appl. No.: 13/397,433

(22) Filed: Feb. 15, 2012

(51) Int. Cl. G06F 3/041

(52) U.S. Cl. 345/173

(57) ABSTRACT

In accordance with the teachings of the present disclosure, a touch-screen device may include a touch-screen display and a display manager. The touch-screen display may include a display device configured to display at least one of graphical images and alphanumeric text and a touch sensor configured to detect a tactile touch proximate to the touch sensor. The display manager may be configured to receive an indication of a manifestation of a desire of a user of the touch-screen device to disable at least a portion of the touch sensor and in response to the indication, disable at least a portion of the touch sensor while maintaining a display present on the display device substantially similar to that immediately before the user manifested the desire to disable at least a portion of the touch sensor.

### TECHNICAL FIELD

The present disclosure relates in general to touch-screen devices, and more particularly to systems and methods for providing an input lock function for a touch-screen device.

### BACKGROUND

As communications and computer technology has advanced, users are increasingly using touch-screen devices (e.g., desktop computers, laptop computers, tablet computers, personal digital assistants (PDAs), smartphones, satellite navigation devices, portable media players, portable game consoles, kiosk computers, point-of-sale devices, etc.) for entertainment and the conduct of business. Such touch-screen devices often include touch-screen displays. A touch-screen display is a user interface device that typically operates as both an input and an output device. For example, a touch-screen display may typically include a display device for displaying alphanumerical information and/or graphical images as output to a viewer of the touch-screen display and a touch sensor overlaid on the display device that may detect the presence and location of a touch or the proximity of an object (such as a user's finger or a stylus) within a touch-sensitive area of the touch sensor, thus receiving input from a user. There are a number of different types of touch sensors, such as (for example) resistive touch screens, surface acoustic wave touch screens, and capacitive touch screens.

One disadvantage of touch-screen devices are that touch screens are susceptible to accidental or errant touches that may cause undesired user input to the touch-screen device. To address this disadvantage, traditional touch-screen devices permit a user to “lock” a touch-screen device such that the touch screen is substantially disabled from receiving further input. However, when locking a touch-screen device, traditional touch-screen devices either disable the output function of the touch screen or significantly modify the output to the display device from the output displayed immediately before the touch-screen device was locked.

### SUMMARY

In accordance with the teachings of the present disclosure, a touch-screen device may include a touch-screen display and a display manager. The touch-screen display may include a display device configured to display at least one of graphical images and alphanumeric text and a touch sensor configured to detect a tactile touch proximate to the touch sensor. The display manager may be configured to receive an indication of a manifestation of a desire of a user of the touch-screen device to disable at least a portion of the touch sensor and in response to the indication, disable at least a portion of the touch sensor while maintaining a display present on the display device substantially similar to that immediately before the user manifested the desire to disable at least a portion of the touch sensor.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example touch-screen device, in accordance with one or more embodiments of the present disclosure;

FIG. 2 illustrates a flow chart of an example method for disabling a touch sensor of a touch-screen device, in accordance with one or more embodiments of the present disclosure; and

FIGS. 3-6 illustrate example user interface interactions for disabling or enabling a touch sensor of a touch-screen device, in accordance with one or more embodiments of the present disclosure.

### DETAILED DESCRIPTION

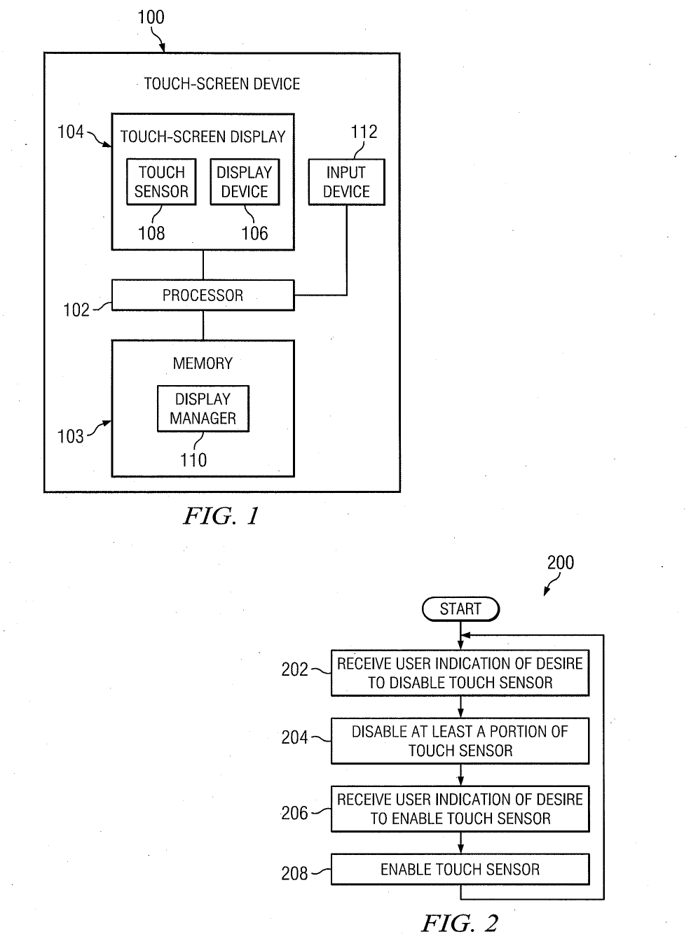

Preferred embodiments and their advantages are best understood by reference to FIGS. 1-6, wherein like numbers are used to indicate like and corresponding parts.

For purposes of this disclosure, a touch-screen device may include any instrumentality or aggregate of instrumentalities having a touch-screen display, wherein such device is operable to compute, classify, process, transmit, receive, retrieve, originate, switch, store, display, manifest, detect, record, reproduce, handle, or utilize any form of information, intelligence, or data for business, scientific, control, or other purposes. For example, a touch-screen device may be a personal computer (e.g., desktop computer, laptop computer, notebook computer, tablet computer), a smart phone (e.g., a Blackberry or iPhone), a personal digital assistant (PDA), satellite navigation device, portable media player, portable game console, kiosk computer, point-of-sale device, or any other suitable device and may vary in size, shape, performance, functionality, and price. The touch-screen device may include random access memory (RAM), one or more processing resources such as a central processing unit (CPU) or hardware or software control logic, ROM, and/or other types of nonvolatile memory. Additional components of the touch-screen device may include one or more disk drives, one or more network ports for communicating with external devices as well as various input and output (I/O) devices, including the touch-screen display. A touch-screen device may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example touch-screen device 102, in accordance with one or more embodiments of the present disclosure. As depicted in FIG. 1, touch-screen device 102 may include a processor 102, a memory 103, a touch-screen display 104, and one or more input devices 112.

Processor 102 may comprise any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 103 and/or another component of touch-screen device 100. In the same or alternative embodiments, processor 102 may communicate data (e.g., alphanumeric text and/or graphical images) for display to a user on touch-screen display 104 and/or receive user input from a user via touch-screen display 104. In these and alternative embodiments, processor 102 may be configured to receive data from actuator 112 indicative of a user interaction with input device 112.

Memory 103 may be communicatively coupled to processor 102 and may comprise any system, device, or apparatus configured to retain program instructions or data for a period of time (e.g., computer-readable media). Memory 103 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to touch-screen device 100 is turned off.

As shown in FIG. 1, memory 103 may have stored thereon a display manager 110. Display manager 110 may include one or more programs of instructions that when, executed by processor 102, may be configured to based on user input via touch-screen display 104, actuator 112, and/or other user interface, selectively enable and disable touch sensor 108 or a portion thereof and/or generate a display to display device 106 of touch-sensor display 104. This and other functionality of display manager 110 may be described in further detail below. Although depicted as a program of instructions embodied in memory 103, all or a portion of document viewer module 106 may be embodied in hardware, firmware, or software stored on a computer-readable medium (e.g., memory 103 or computer-readable media external to memory 103). In some embodiments, display manager 110 may be an integral part of an operating system present on touch-screen device 100. In other embodiments, display manager 110 may be an application program configured to execute on an operating system present on touch-screen device 100.

Touch-screen display 104 may be communicatively coupled to processor 102 and may include any system, apparatus, or device suitable for creating graphic images and/or alphanumeric characters recognizable to a user and for detecting the presence and/or location of a tactile touch upon touch-screen display 104. As shown in FIG. 1, touch-screen display 104 may include a display device 106 and a touch sensor 108. Display device 106 may include any system, apparatus, or device suitable for creating graphic images and/or alphanumeric characters recognizable to a user and may include a liquid crystal display (LCD), a light-emitting diode (LED) display, or an organic LED display, or other suitable display. Touch sensor 108 may be mechanically coupled or overlaid upon display device 106 and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor.

Input device 112 may be communicatively coupled to processor 102 and may include a system, apparatus, or device separate from touch-screen display 104 configured to receive user input from a user and communicate a signal indicative of such input to processor 102. For example, input device 112 may include one or more of a button, switch, or toggle. In some embodiments input device 112 may comprise an accelerometer or other device configured to determine a position or other motion of touch-screen device relative to the center of the earth. In some embodiments input device 112 may comprise a biometric reader. In these and other embodiments, input device 112 may be configured to receive an input indicative of a user desire to lock or unlock touch-screen display 104. Although FIG. 1 depicts touch-screen device 100 having one input device 112, touch-screen device 100 may include any suitable number and/or types of input devices (including no input devices 112).

In operation, a user may indicate via touch-screen display 104 and/or input device 112 that the user desires to disable or “lock” the touch sensor 108 capability of touch-screen display 104 while maintaining a display present on display device 106 substantially similar to that immediately before the user manifested the desire to disable touch sensor 108 capability. In response to receiving such an indication, display manager 110 and/or another component of touch-screen device 100 may disable at least a portion of touch sensor 108 while maintaining a display present on display device 106 substantially similar to that immediately before the user manifested the desire to disable touch sensor 108 capability. In some embodiments, a portion of touch sensor 108 may remain enabled in order to receive a user manifestation of a desire to enable the remaining touch sensor 108.

As used herein, maintaining the display present on display device 106 to be “substantially similar” means displaying, after the user's manifestation of the desire to disable touch sensor 108 capability, a majority of graphical elements present prior to the user's manifestation of the desire to disable touch sensor 108 capability, at approximately the same pixel locations. For example, if a user manifests a desire to disable touch sensor 108 capability while display device 106 shows a “home screen” of application icons, touch-screen device 100 may disable at least a portion touch sensor 108 input but continue to display the home screen. As another example, if a user manifests a desire to disable touch sensor 108 capability while display device 106 displays an application, touch-screen device 100 may disable at least a portion of touch sensor 108 input but continue to display the application. As a further example, if a user manifests a desire to disable touch sensor 108 capability while display device 106 is displaying and playing a video, touch-screen device 100 may disable at least a portion of touch sensor 108 input but continue to display the video.

As used herein, disabling at least a portion of touch sensor 108 broadly includes any action taken by display manager 110 and/or another component of touch-screen device 100 to disable processing of at least some tactile touches on touch sensor 108. For example, in some embodiments, disabling at least a portion of touch sensor 108 may comprise withdrawing power to touch sensor 108 preventing it from detecting tactile touches. As another example, in other embodiments, disabling at least a portion of touch sensor 108 may comprise display manager 110 causing signals indicative of tactile touches to touch sensor 108 or a portion thereof to be ignored or discarded by processor 102. As a further example, in other embodiments, disabling at least a portion of touch sensor 108 may comprise display manager 110 causing certain signals indicative of tactile touches to touch sensor 108 or a portion thereof to be ignored or discarded by processor 102 while others are processed (e.g., a pre-defined touch, action, or gesture upon touch sensor 108 may cause display manager 110 to again enable touch sensor 108 for all touches).

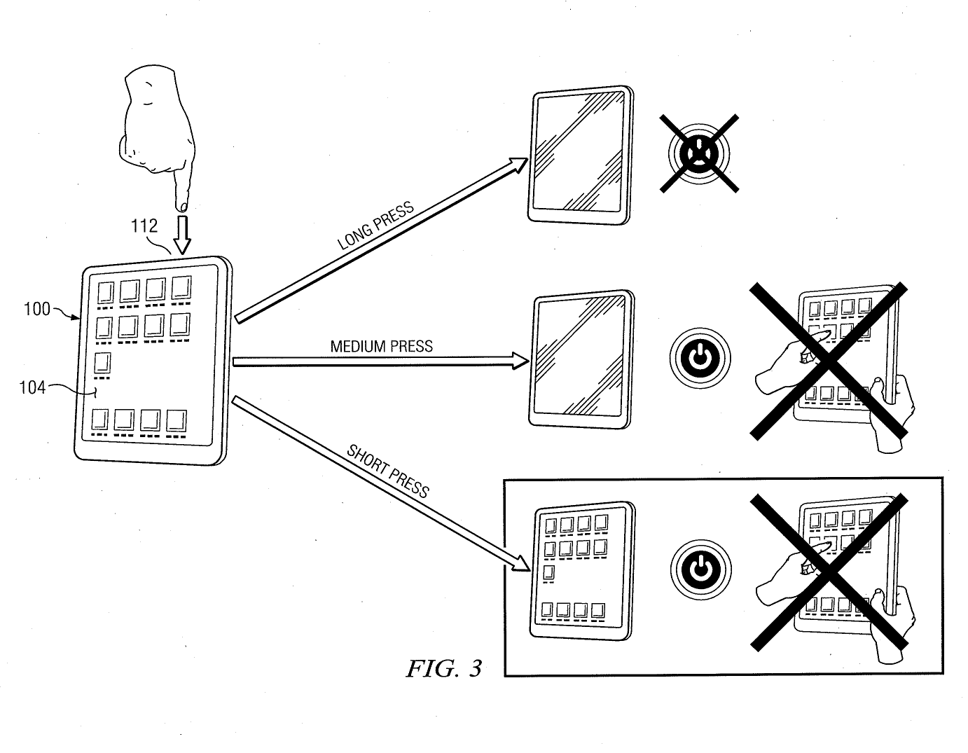

When touch sensor 108 is disabled, a user may manifest a desire to again enable touch sensor 108 (or disabled portions thereof) by providing an appropriate tactile input to touch screen display 104 (e.g., proximate to a portion of touch sensor 108 remaining enabled when the remainder of touch sensor was disabled) and/or by providing an indication via input device 112 that the user desires to enable touch sensor 108. Examples of user interactions that may be used to enable and/or disable touch sensor 108 (or a portion thereof) are described in greater detail below with respect to FIGS. 3-6.

FIG. 2 illustrates a flow chart of an example method 200 for disabling a touch sensor of a touch-screen device (e.g., touch-screen device 100), in accordance with one or more embodiments of the present disclosure. As noted above, teachings of the present disclosure may be implemented in a variety of configurations of touch-screen device 100. As such, the preferred initialization point for method 200 and the order of the steps 202-208 comprising method 200 may depend on the implementation chosen.

At step 202, a touch-screen device (e.g., touch-screen device 100) may receive a user indication via a touch-screen display (e.g., touch-screen display 104) and/or another input device (e.g., input device 112) that the user desires to disable touch sensor capability of the touch-screen display while maintaining a display present on display device substantially similar to that immediately before the user manifested the desire to disable touch sensor capability.

At step 204, in response to the user indication to disable touch sensor capability, the touch-screen device may disable at least a portion of a touch sensor (e.g., touch sensor 108) of the touch-screen display, while maintaining a display present on a display device (e.g., display device 106) of the touch-screen display substantially similar to that immediately before the user manifested the desire to disable touch sensor capability. After the touch sensor is disabled, the touch-screen device (or disabled portions thereof) may not process tactile touches proximate to the touch sensor. In certain embodiments, a portion of the touch sensor may remain enabled to allow the user to manifest a desire to again enable the remainder of the touch sensor.

At step 206, the touch-screen device may receive a user indication via the touch-screen display (e.g., proximate to a portion of the touch sensor not disabled when the remainder of the touch sensor was disabled at step 204) and/or another input device that the user desires to again enable the touch sensor capability of the touch-screen display.

At step 208, in response to the user indication to again enable touch sensor capability, the touch-screen device may enable the touch sensor (or portions thereof that were disabled). After completion of step 208, method 200 may return to step 202.

Although FIG. 2 discloses a particular number of steps to be taken with respect to method 200, it is understood that method 200 may be executed with greater or lesser steps than those depicted in FIG. 2. In addition, although FIG. 2 discloses a certain order of steps to be taken with respect to method 200, the steps comprising method 200 may be completed in any suitable order. Method 200 may be implemented using touch-screen device 100 or any other system operable to implement method 200. In certain embodiments, method 200 may be implemented partially or fully in software embodied in computer-readable media. In these and other embodiments, method 200 may be implemented in whole or part by display manager 110.

FIGS. 3-6 illustrate example user interface interactions for disabling or enabling touch sensor 108 of a touch-screen device 100, in accordance with one or more embodiments of the present disclosure. In the example depicted in FIG. 3, a user may interact with an input device 112 in the form of a button. By depressing the button for a first duration of time (e.g., for approximately 1 second) the user may indicate a desire to disable touch sensor 108 while maintaining display device 106 while maintaining a display present on display device substantially similar to that immediately before the user manifested the desire to disable touch sensor capability. In addition, by depressing the button for a second duration of time (e.g., for approximately 3 seconds) the user may indicate a desire to disable touch sensor 108 and display device 106, thus placing touch-screen device 100 in a “standby mode” in which components of touch-screen device 100 other than touch-screen display 104 remain powered on. Furthermore, by depressing the button for a third duration of time (e.g., for approximately 7 seconds) the user may indicate a desire to completely power off touch-screen device 100.

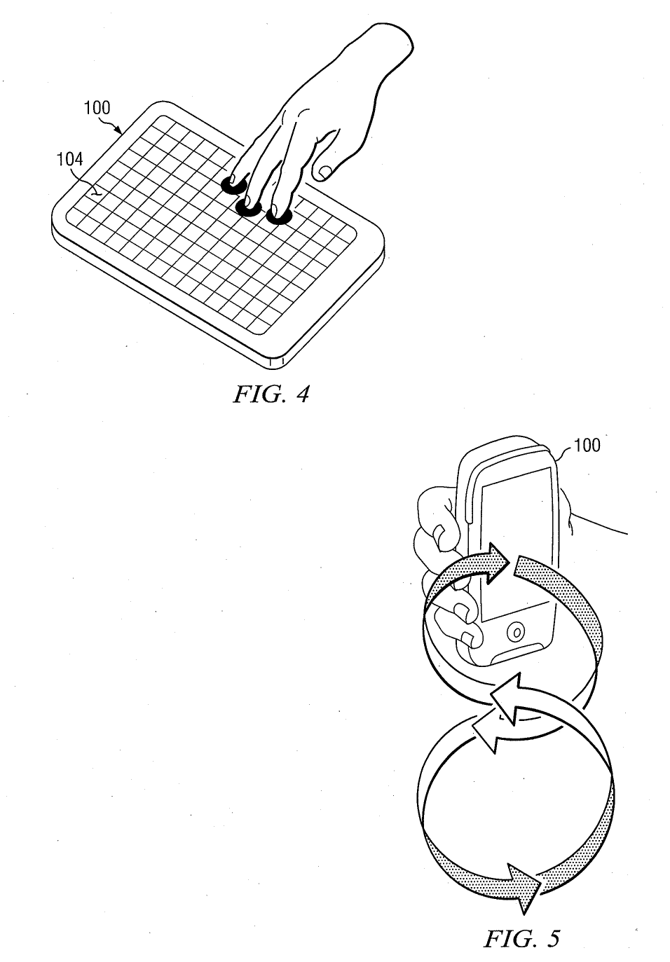

In the example depicted in FIG. 4, a user may interact with touch-screen display 104 with particular types of touches or gestures indicative of a desire to enable or disable touch sensor 108, such as touching three fingers in a particular orientation or location upon touch-screen display 104. Another example of a type of touch or gesture that a user may make to manifest a desire to enable or disable touch sensor 108 may include tracing a particular shape or letter upon touch-screen display 104 (e.g., tracing a “U” shape to enable touch sensor 108).

In the example depicted in FIG. 5, a user may interact with a input device 112 capable of detecting motion and/or orientation of touch-screen device 100 (e.g., an accelerometer) to indicate a desire to enable or disable touch sensor 108. As a particular example, a user may move touch-screen device in a circular manner to indicate a desire to enable or disable touch sensor 108. As another particular example, a user may move touch-screen device in a “figure-8” pattern to indicate a desire to enable or disable touch sensor 108.

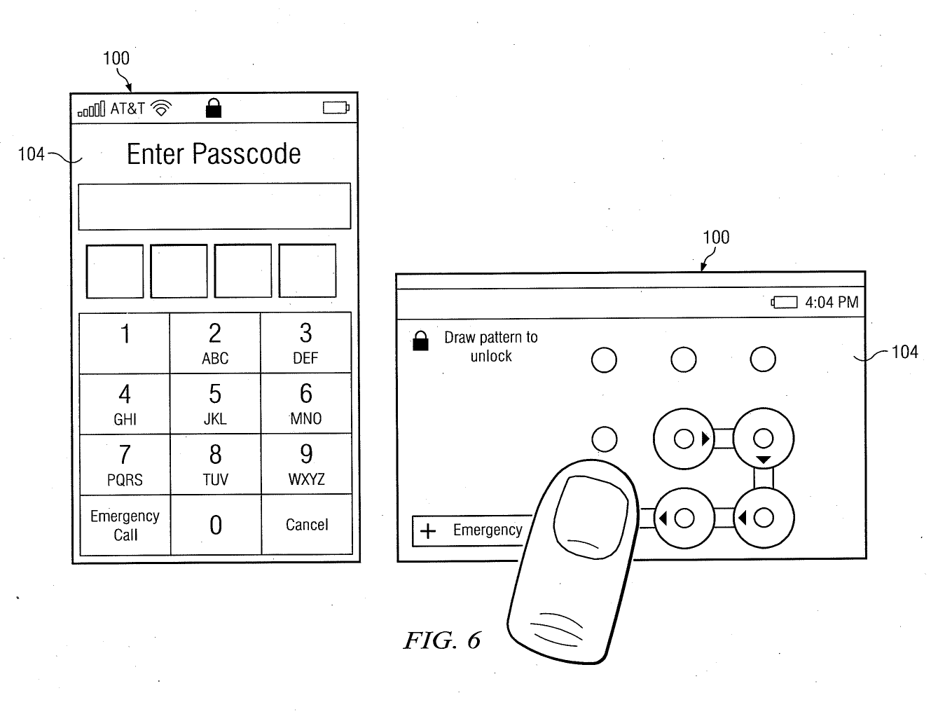

In the example depicted in FIG. 6, a user may indicate a desire to enable or disable touch sensor 108 by entering a pre-defined code or gesture.

In another example (not pictured) a user may enter biometric information (e.g., voice recognition, palm vein, fingerprint, picture, etc.) to indicate a desire to enable or disable touch sensor 108

Although the present disclosure has been described in detail, it should be understood that various changes, substitutions, and alterations can be made hereto without departing from the spirit and the scope of the invention as defined by the appended claims.

What is claimed is:

1. A touch-screen device comprising:
a touch-screen display having:
a display device configured to display at least one of graphical images and alphanumeric text; and
a touch sensor configured to detect a tactile touch proximate to the touch sensor; and
a display manager configured to:
receive an indication of a manifestation of a desire of a user of the touch-screen device to disable at least a portion of the touch sensor; and
in response to the indication, disable at least a portion of the touch sensor while maintaining a display present on the display device substantially similar to that immediately before the user manifested the desire to disable at least a portion of the touch sensor.

2. A touch-screen device in accordance with claim 1, the touch-screen device comprising a processor, wherein the display manager comprises a program of instructions configured to execute on the processor.

3. A touch-screen device in accordance with claim 1, the touch sensor configured to:
detect an interaction of a user with the touch-screen display indicative of the manifestation of the desire of the user to disable at least a portion of the touch sensor; and
communicate to the display manager the indication of the manifestation of the desire of the user to disable at least a portion of the touch sensor in response to detecting the interaction.

4. A touch-screen device in accordance with claim 3, the interaction comprising at least one of a touch indicative of the desire to disable the touch sensor and a gesture indicative of the desire to disable the touch sensor.

5. A touch-screen device in accordance with claim 3, the interaction comprising input of a code indicative of the desire to disable the touch sensor.

6. A touch-screen device in accordance with claim 1, further comprising an input device configured to:
detect an interaction of a user with the input device indicative of the manifestation of the desire of the user to disable at least a portion of the touch sensor; and
communicate to the display manager the indication of the manifestation of the desire of the user to disable at least a portion of the touch sensor in response to detecting the interaction.

7. A touch-screen device in accordance with claim 6, the input device comprising a button.

8. A touch-screen device in accordance with claim 7, the interaction comprising depressing the button for a duration of time.

9. A touch-screen device in accordance with claim 8, the button configured to:
detect a second interaction of the user indicative of a manifestation of the desire of the user to place the touch-screen device in a standby mode in order disable at least a portion of the touch sensor and disable the display device while leaving other components of the touch-screen device in a powered state; and
communicate to the display manager the indication of the manifestation of the desire of the user to place the touch-screen device in the standby mode in response to detecting the second interaction.

10. A touch-screen device in accordance with claim 9, the second interaction comprising depressing the button for a second duration of time.

11. A touch-screen device in accordance with claim 8, the button configured to:
detect a second interaction of the user indicative of a manifestation of the desire of the user to power off the touch-screen device; and
communicate the indication of the manifestation of the desire of the user to power off the touch-screen device.

12. A touch-screen device in accordance with claim 11, the second interaction comprising depressing the button for a second duration of time.

13. A touch-screen device in accordance with claim 6, the input device comprising a biometric sensor.

14. A touch-screen device in accordance with claim 6, the input device comprising an accelerometer configured to detect at least one of a motion of the touch-screen device and orientation of the touch-screen device, wherein the interaction comprises at least one of a particular movement of the touch-screen device and placement of the touch-screen device in a particular orientation.

15. A touch-screen device in accordance with claim 1, a display manager configured to, while at least a portion of the touch-screen is disabled:
receive a second indication of a manifestation of a desire of the user of the touch-screen device to enabled the touch sensor; and
in response to the second indication, enable the touch sensor.

16. A touch-screen device in accordance with claim 1, the touch sensor configured to:
detect an interaction of a user with the touch-screen display indicative of the manifestation of the desire of the user to enable the touch sensor; and
communicate to the display manager the indication of the manifestation of the desire of the user to enable the touch sensor.

17. A touch-screen device in accordance with claim 1, further comprising an input device configured to:
detect an interaction of a user with the input device indicative of the manifestation of the desire of the user to enable the touch sensor; and
communicate to the display manager the indication of the manifestation of the desire of the user to enable the touch sensor in response to detecting the interaction.

18. A touch-screen device in accordance with claim 17, the input device comprising one of a button, a biometric reader, and an accelerometer.

19. A method comprising:
receiving an indication of a manifestation of a desire of a user of a touch-screen device to disable at least a portion of a touch sensor, the touch-screen device comprising a touch-screen display comprising the touch sensor; and
in response to receiving the indication, disabling at least a portion of the touch sensor while maintaining a display present on a display device substantially similar to that immediately before the user manifested the desire to disable at least a portion of the touch sensor, the touch-screen display comprising the display device.
